(19) United States
(12) Patent Application Publication
(10) Pub. No.: US 2013/0270334 A1
(43) Pub. Date: Oct. 17, 2013

(54) Pocket Assembly For A Shipping Container

(71) Applicant: SAXON, INC., Ferndale, MI (US)

(72) Inventors: James F. Turner, Farmington Hills, MI (US); Scott D. Best, Troy, MI (US)

(21) Appl. No.: 13/861,974

(22) Filed: Apr. 12, 2013

Related U.S. Application Data
(60) Provisional application No. 61/686,823, filed on Apr. 12, 2012.

(51) Int. Cl. B65D 27/34; B31B 19/20

(52) U.S. Cl. CPC B65D 27/34; B31B 19/20
USPC 229/316; 493/228

(57) ABSTRACT

A pocket assembly for a shipping container, a shipping container assembly, and a method of manufacturing a pocket assembly for a shipping container are disclosed herein.

### CROSS REFERENCE TO RELATED APPLICATION

This application claims priority to and all the benefits of U.S. Provisional Patent Application Ser. No. 61/686,823 filed on Apr. 12, 2012, the entire specification of which is expressly incorporated herein by reference.

### BACKGROUND

1. Field of the Disclosure

The present disclosure relates generally to a pocket assembly, and more specifically, to a pocket assembly for a shipping container.

2. Description of the Related Art

Products are typically shipped to consumers in shipping containers such as boxes, crates, bags, or other suitable packaging structures. Printed materials, such as shipping labels, receipts, identifiers, etc., may be placed inside a pocket assembly that is mounted on at least one wall of the shipping container. Lack of air circulation inside the pocket assembly may, however, adversely affect the integrity of the printed materials placed inside the pocket assembly when the shipping container is, for example, exposed to certain environmental conditions. Additionally, currently available pocket assemblies may be easily torn or otherwise destroyed during use thereof.

### SUMMARY

A pocket assembly for a shipping container is disclosed. The pocket assembly comprises a back layer comprising first and second opposing back ends and top and bottom back edges extending between the back ends with the back edges spaced from each other along the back ends to define interior and exterior back sides. The pocket assembly further includes a front layer coupled to the back layer. The front layer comprises first and second opposing front ends and top and bottom front edges extending between the front ends with the front edges spaced from each other along the front ends to define interior and exterior front sides. A first score line is spaced inward from the first front end and a second score line is spaced inward from the second front end. A first cut extends inward from the first front end and intersects the first score line to define first and second segments. The first segment is bound by the first front end, the first score line, the top front edge, and the first cut, and the second segment is bound by the first front end, the first cut, and the bottom front edge. A second cut extends inward from the second front end and intersects the second score line to define third and fourth segments. The third segment is bound by the second front end, the second score line, the top front edge, and the second cut, and the fourth segment is bound by the second front end, the second cut, and the bottom front edge. The first and third segments are folded along respective first and second score lines such that the first and third segments abut and adhere to the interior back side of the back layer to form a pouch between the front and back layers. The second and fourth segments remain spaced from the back layer to form first and second openings, respectively, in fluid communication with the pouch.

Also disclosed are a shipping container assembly and a method of manufacturing a pocket assembly for the shipping container assembly.

### BRIEF DESCRIPTION OF THE DRAWINGS

Advantages of the present disclosure will be readily appreciated, as the same becomes better understood by reference to the following detailed description, when considered in connection with the accompanying drawings.

FIG. 1 illustrates an example of a shipping container assembly. It is to be understood that the shipping container assembly shown in FIG. 1 is not drawn to scale.

FIG. 2 is a front view of an example of a pocket assembly for a shipping container.

FIG. 3 is a rear view of the pocket assembly of FIG. 2.

FIG. 4 is an end view of a back layer of the pocket assembly of FIG. 3. It is to be understood that FIG. 4 is not drawn to scale.

FIG. 5 a front view of a portion of the pocket assembly of FIG. 2.

FIG. 6 is an end view of the portion of the pocket assembly of FIG. 5. It is to be understood that FIG. 6 is not drawn to scale.

FIG. 7 depicts an example of a sheet for use in a method of manufacturing the pocket assembly, where the sheet includes a back layer coupled to a front layer at respective bottom edges, thereby forming a seam.

FIG. 8 depicts the sheet of FIG. 7, which further includes a first cut that intersects a first score line formed in the front layer to define first and second segments, and a second cut that intersects a second score line formed in the front layer to define third and fourth segments.

FIG. 9 depicts the sheet of FIG. 8, which further includes the first and third segments folded along respective first and second score lines.

FIG. 10 depicts the sheet of FIG. 9, which further includes peelable strips being removed from the first and third segments to expose an underlying adhesive.

FIG. 11 depicts the sheet of FIG. 10, where the front layer is folded along the seam so that the first and third segments abut and adhere to the back layer.

FIG. 12 depicts the pocket assembly formed by performing the manufacturing steps described with reference to FIGS. 7-11.

### DETAILED DESCRIPTION

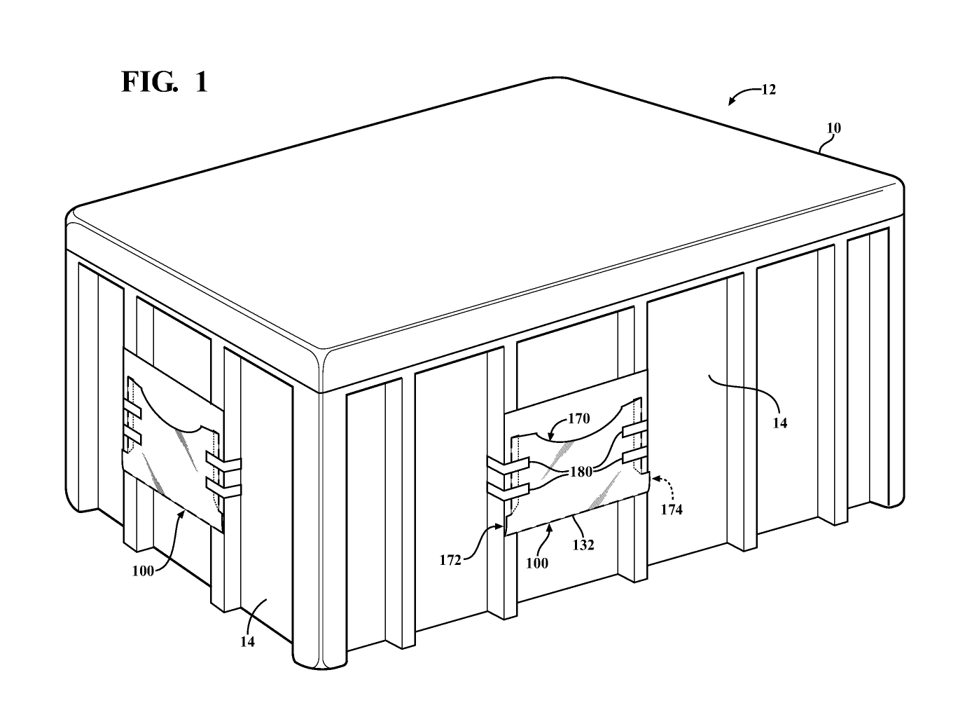

Referring now to the figures, wherein like numerals indicate corresponding parts throughout the several views, examples of a pocket assembly 100 are shown throughout the figures and are described in detail below. The examples of the pocket assembly 100 are designed to hold shipping labels, notification cards, identifiers, and/or other printed materials within a pouch 170. The pocket assembly 100 is also designed to be coupled to a shipping container 10, as shown in FIG. 1. Examples of shipping containers 10 include shipping crates, shipping boxes, shipping bags, and other packaging structures that are suitable for shipping products.

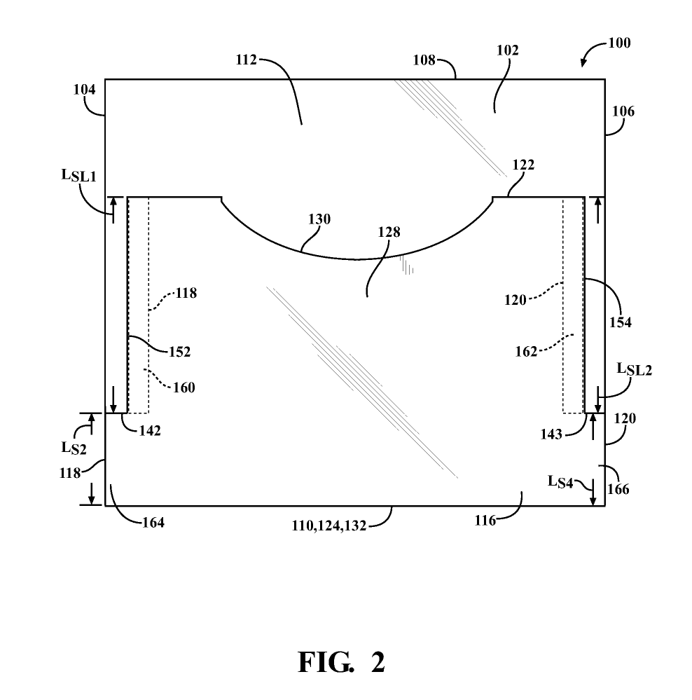

Examples of the pocket assembly 100 are shown in and described with reference to FIGS. 2-6. The pocket assembly 100 includes a back layer 102 having opposing first 104 and second 106 ends with top 108 and bottom 110 edges of the back layer 102 extending between the opposing first 104 and second 106 ends. The top 108 and bottom 110 edges are spaced from each other along the first 104 and second 106 ends to define an interior side 112 (shown in FIGS. 2 and 4) and an exterior side 114 (shown in FIG. 4) of the back layer 102. In the examples shown in the figures, the back layer 102 has a rectangular shape. It is to be understood, however, that the back layer 102 may have another shape, such as a square shape. Further, the first end 104, the second end 106, and/or the top edge 108 of the back layer 102 may be straight/substantially straight, curved, or combinations thereof.

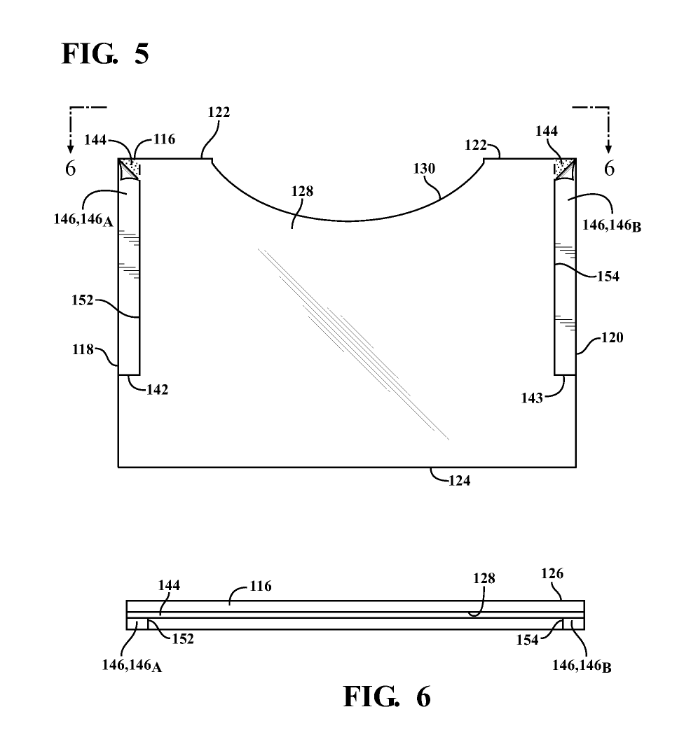

The pocket assembly 100 further includes a front layer 116 that is coupled to the back layer 102. The front layer 116 has opposing first 118 and second 120 ends with top 122 and bottom 124 edges of the front layer 116 extending between the opposing first 118 and second 120 ends. The top 122 and bottom 124 edges are spaced from each other along the first 118 and second 120 ends to define an interior side 126 (shown in FIG. 6) and an exterior side 128 (shown in FIGS. 2, 5, and 6) of the front layer 116. In the examples shown in the figures, the front layer 116 has a generally rectangular shape that is defined by the first end 118, the second end 120, the top edge 122, and the bottom edge 124. In an example, and as shown in FIGS. 2 and 5, the top edge 122 of the front layer 116 has a semi-circular cut 130 formed therein. This semi-circular cut 130 may be used to facilitate insertion of the printed material into a pouch 170 (shown in FIGS. 1 and 12) of the pocket assembly 100.

The back 102 and front 116 layers are coupled to one another along the respective bottom edges 110, 124 to form a seam 132 at the bottom edges 110, 124. In an example, the seam 132 is perforated (as shown in FIG. 1) to allow air circulation within the pouch 170 and to allow for draining of any liquids that are captured within the pouch 170. In an example, the seam 132 is perforated by including a series of cuts along the length of the seam 132.

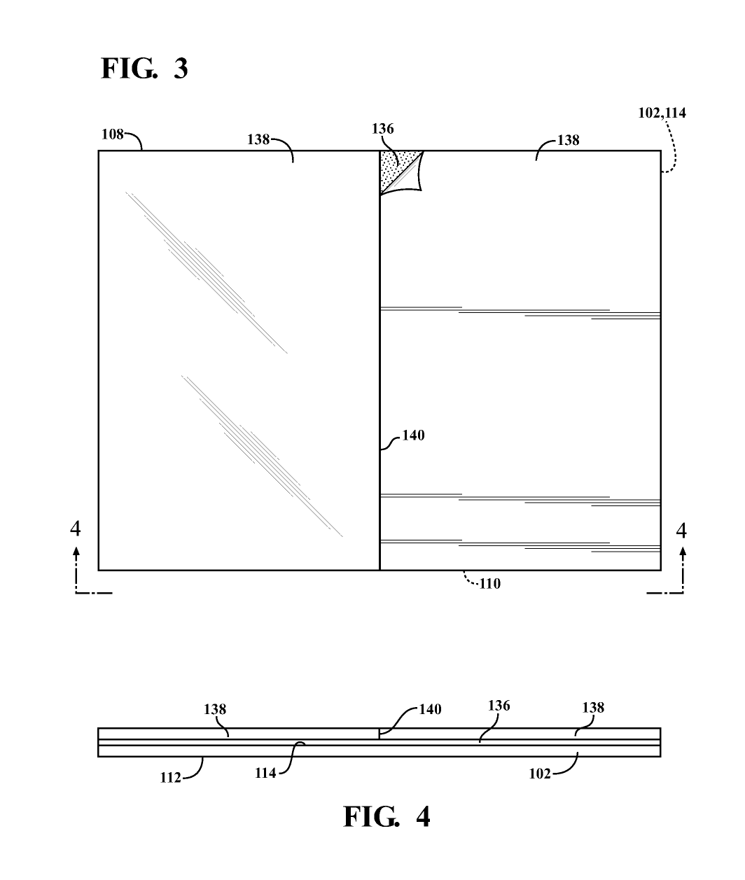

Referring to FIGS. 3 and 4, in an example, the pocket assembly 100 includes an adhesive layer 136 disposed on at least a portion of the exterior side 114 of the back layer 102, and a peelable layer 138 disposed on the adhesive layer 136. The peelable layer 138 is generally peelable or otherwise removable from the adhesive layer 136 to expose the underlying adhesive layer 136. In one example, which is not shown in the figures, the peelable layer 138 is peelable off a corner of the back layer 102. In another example, and as shown in FIGS. 3 and 4, the peelable layer 138 is scored to form a score line 140 so that sections of the peelable layer 138 can be removed. For instance, the back layer 102 may be bent along the score line 140 so that section(s) of the peelable layer 138 may be peeled off as shown in FIG. 3.

In another example, the back layer 102 may be a multi-layered structure including a base layer with an adhesive layer disposed on the base layer, and a peelable layer disposed on the adhesive layer. In this example, the base layer includes the interior side 112 of the back layer 102 and the peelable layer includes the exterior side 114 of the back layer 102.

The adhesive used for the adhesive layer 144 may be selected from any suitable adhesive. In an example, the adhesive is a strong adhesive to prevent the back layer 102 from being removed from the wall(s) 14 of the shipping container 10.

Referring now to FIGS. 2, 5, and 6, in an example, the front layer 116 includes a first cut 142 extending inward from the first end 118 and a second cut 143 extending inward from the second end 120. The cuts 142, 143 may be formed using any suitable cutting method.

In an example, the pocket assembly 100 further includes an adhesive layer 144 disposed on at least a portion of the exterior side 128 of the front layer 116, and a peelable layer 146 is disposed over the adhesive layer 144. The peelable layer 146 is generally peelable or otherwise removable from the adhesive layer 144 to expose the underlying adhesive layer 144. In an example, first 146_{A} and second 146_{B} strips of the peelable layer 146 are removed from the front layer 116 along first 152 and second 154 score lines formed in the front layer 116. The first score line 152 is spaced inward from the first end 118 of the front layer 116 and the second score line 154 is spaced inward from the second end 120 of the front layer 116. The first score line 152 may be formed by scoring the peelable layer 146 along a predefined line extending from the top edge 122 of the front layer 116 to the first cut 142. The second score line 154 may be formed by scoring the peelable layer 146 along a predefined line extending from the top edge 122 to the second cut 143. By this design, the first cut 142 intersects the first score line 152 and the second cut 143 intersects the second score line 154. It is to be understood that the first cut 142 does not extend beyond the first score line 152 when the first cut 142 intersects the first score line 152. Likewise, the second cut 143 does not extend beyond the second score line 154 when the second cut 143 intersects the second score line 154.

In an example, the first score line 152 has a length L_{SL1} defined between the top edge 122 of the front layer 116 and the first cut 142, and the second score line 154 has a length L_{SL2} defined between the top edge 122 and the second cut 143. In an example, the lengths L_{SL1} and L_{SL2} are substantially the same. In another example, the lengths L_{SL1} and L_{SL2} are different.

In an example, the first 152 and second 154 score lines are perforated. In an example, the first 152 and second 154 score lines are perforated such that the individual perforations extend through the front layer 116. In another example, the first 152 and second 154 score lines are perforated such that the individual perforations do not extend through the front layer 116. In some instances, the peelable layer 146 may be scored while the front layer 116 remains unscored and the front layer 116 is folded without the assistance of scoring. These instances may be useful when the front layer 116 is formed of a softer, less durable material such as a paper-based material.

As shown in FIG. 2, the first cut 142, the first score line 152, the top edge 122, and the first end 118 defines a first segment 160 of the front layer 116. Likewise, and as also shown in FIG. 2, the second cut 143, the second score line 154, the top edge 122, and the second end 120 defines a third segment 162 of the front layer 116. In an example, the peelable strips 146_{A} and 146_{B} are removed to expose the adhesive layer 144 on the respective first 160 and third 162 segments of the front layer 116. As will be described further in conjunction with a method of manufacturing the pocket assembly 100, exposure of the adhesive layer 144 facilitate adherence of the first 160 and third 162 segments to the interior side 112 of the back layer 102.

In addition to the first segment 160, the first cut 142 also defines a second segment 164 that extends between the first cut 142 and the bottom edge 124 of the front layer 116. Likewise, in addition to the third segment 162, the second cut 143 also defines a fourth segment 166 that extends between the second cut 143 and the bottom edge 124. Furthermore, the second segment 164 has a length L_{S2} defined between the first cut 142 and the bottom edge 124 of the front layer 116 and the fourth segment 166 has a length L_{S4} defined between the second cut 143 and the bottom edge 124 of the front layer. In an example, the lengths L_{S2} and L_{S4} are substantially the same. In another example, the lengths L_{S2} and L_{S4} are different.

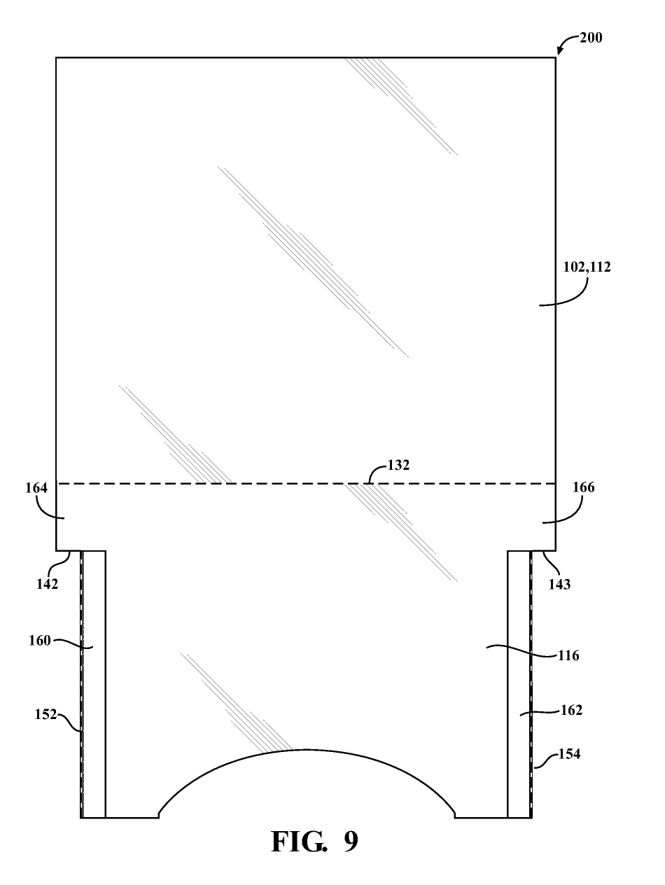

In an example, the peelable layer 146 (i.e., the peelable strips 146_{A} and 146_{B}) is removed from the first 160 and third 162 segments of the front layer 116, and the first 160 and third 162 segments are folded along the respective first 152 and second 154 score lines. This is shown at least in FIG. 9 which will be described further below in conjunction with an example of a method of manufacturing the pocket assembly 100. The folded first 160 and third 162 segments abut and adhere, by virtue of the exposed adhesive layer 144, to the interior side 112 of the back layer 102 to form the pouch 170 between the back 102 and front 116 layers. The second 164 and fourth 166 segments, however, remain spaced from the back layer 102 to form first 172 and second 174 openings, respectively, that are in fluid communication with the pouch 170. The openings 172, 174 are shown in FIGS. 1 and 12, and the presence of the openings 172, 174 contribute to air circulation inside the pouch 170 as well as drainage for undesirable fluids (e.g. water) that may enter the pouch 170. In an example, the first opening 172 is defined by the second segment 164, the bottom front edge 124, the bottom back edge 110, and the first end 104 of the back layer 102, and the second opening 174 is defined by the fourth segment 166, the bottom front edge 124, the bottom back edge 110, and the second back end 106.

The back 102 and front 116 layers are generally formed of a synthetic material, a paper-based material, or combinations thereof. In one example, each of the back 102 and the front 116 layers are formed of a synthetic material that is very durable and cannot be readily torn by human hands. Examples of synthetic materials include a polyester, a polypropylene, and/or the like. Additionally, the material selected for the back 102 and front 116 layers may be transparent/substantially transparent to enable a person to see the printed material through the front layer 116 material. Alternatively, the back 102 and front 116 layers may be formed of a combination of a synthetic material and a paper-based material. Additionally, the back 102 and front 116 layers may be formed of either a heavy weight stock material or a light weight stock material so long as the material is sufficiently durable to withstand environmental conditions and/or the elements of nature. The back 102 and/or front 116 layers may also have a glossy or semi-gloss finish.

The back layer 102 may, for instance, be selected from a material that has a color that is different from the front layer 116. As an example, the front layer 116 may have no color (i.e., the front layer 116 is clear/substantially clear) while the back layer 102 is colored rendering the back layer 102 as being semi-transparent or opaque.

In an example, the back 102 and/or the front 116 layers includes a coating disposed on the respective interior sides 112, 126 and/or the respective exterior sides 114, 128. The coating is generally formulated to receive an ink (e.g., a dye-based ink or a pigment-based ink). Accordingly, an ink may be printed on the coated back 102 and/or front 116 layers. In an example, the coating may be a layer formed on the back 102 and/or front 116 layers, or the back 102 and/or front 116 layers may be treated (e.g., chemically treated) so that an ink may be disposed or printed on the back 102 and/or front 116 layers.

Referring back to FIG. 1, an example of a shipping container assembly 12 includes a shipping container 10 having at least one side wall 14 and the pocket assembly 100 coupled to the side wall(s) 14. In the example depicted in FIG. 1, two pocket assemblies 100 are coupled to adjacent side walls 14 of the shipping container 10. It is to be understood that one pocket assembly 100 may be coupled to the shipping container 10 or more than two pocket assemblies may be coupled to the shipping container 10. The side walls(s) 14 of the shipping container 10 may include recesses (as shown in FIG. 1), may be formed of a wire mesh, or may be a smooth surface(s). It should be understood that the pocket assembly 100 may be mounted or adhered to any other suitable surface without deviating from the scope of the present disclosure.

In an example, the pocket assembly 100 is coupled to the side wall(s) 14 of the shipping container 10 by removing the peelable layer 138 to expose the underlying adhesive layer 136 disposed on the back layer 102, and then adhering the pocket assembly 100 to the side wall(s) 14. In another example, the pocket assembly 100 is adhered to the side wall(s) 14 via the adhesive layer 136 and is further secured to the side wall(s) 14 utilizing one or more securing strips 180. The securing strips 180 may be formed of any suitable material. In an example, the securing strips 180 are formed of the same material as the back 102 and front 116 layers. In another example, the securing strips are transparent. Further, each securing strip 180 includes an adhesive on one side thereof for adhering the securing strips to the pocket assembly 100 and the side wall(s) 14 of the shipping container 10. In an example, the pocket assembly 100 may include some indicia or other identifier to assist a user for locating one or more positions for applying the securing strips 180 to the pocket assembly 100.

In the example depicted in FIG. 1, a plurality of securing strips 180 are used to secure the pocket assembly 100 to the shipping container 10. These securing strips 180 are shown in FIG. 1 as being attached to the sides of the pocket assembly 100. It is to be understood that the securing strips 180 may also or otherwise be used at the top and/or bottom of the pocket assembly 100. Further, the securing strips 180 may be larger or smaller than as shown in FIG. 1, for example, the securing strips 180 may have a thinner width than as shown in FIG. 1. Yet further, the securing strips 180 may be spaced further apart or closer together than as shown in FIG. 1.

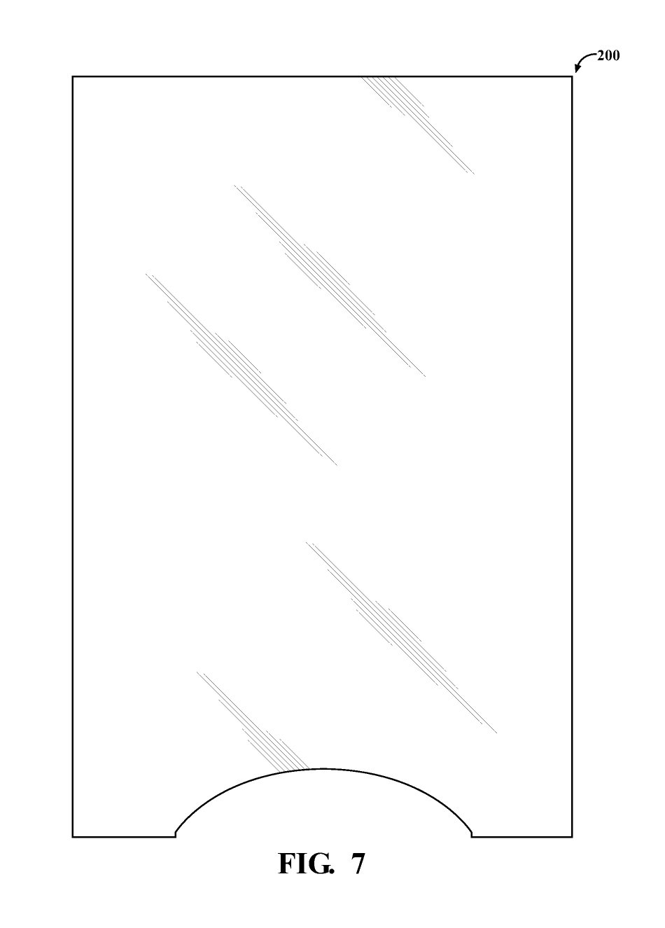

Examples of a method of manufacturing the pocket assembly 100 will now be described with reference to FIGS. 7-12.

In an example, the pocket assembly is manufactured from a sheet 200 having the back layer 102 and the front layer 116 coupled to one another at respective bottom edges 110, 124, forming a seam 132. An example of the sheet 200 is shown in FIG. 7.

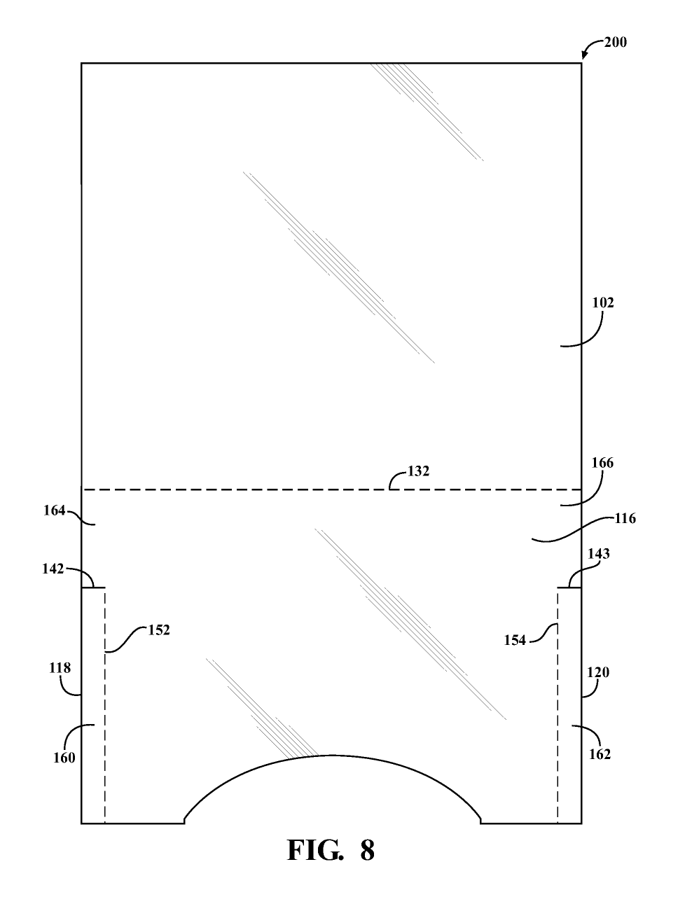

As shown in FIG. 8, the first score line 152 is formed spaced inward from the first end 118 of the front layer 116, and the second score line 154 is formed spaced inward from the second end 120 of the front layer 116. Additionally, the seam 132 is scored. Scoring may be accomplished utilizing a suitable scoring tool. In one example, scoring is accomplished by feeding the sheet 200 into a machine including a scoring tool to score (e.g. perforate) the sheet 200 to form the first 152 and second 154 score lines and the scored seam line 132.

As also shown in FIG. 8, the first cut 142 is formed extending inward from the first end 118 of the front layer 116 and intersecting the first score line 152 to define the first 160 and second 164 segments. Likewise, the second cut 143 is formed extending inward from the second end 120 of the front layer 116 and intersecting the second score line 154 to define the third 162 and fourth 166 segments. The first 142 and second 143 cuts are generally formed using a suitable cutting tool. In an example, cutting to form the cuts 142, 143 is accomplished by feeding the sheet 20 into a machine that includes a cutting tool. The machine used for cutting may be the same machine used for scoring, or may be a different machine. In instances where the same machine is used, the sheet 200 is fed into the machine, where scoring and cutting is accomplished at substantially the same time. In instances where different machines are used, the sheet 200 may be fed to a first machine to perform scoring and then fed to a second machine to perform cutting, or visa versa.

Referring now to FIG. 9, in one example, the first 160 and third 162 segments are folded along the respective first 152 and second 154 score lines. In an example, the sheet 200 is removed from the machine(s), and then the first 160 and third 162 segments are folded. Folding may be accomplished by bending the first 160 and third 162 segments over so that the exterior side (i.e., the exterior side 128) of the segments 160, 162 faces the interior side 112 of the back layer 102. As shown in FIG. 9, when the first 160 and third 162 segments are folded, the second 164 and fourth 166 segments remain spaced from the back layer 102 (i.e., are not folded).

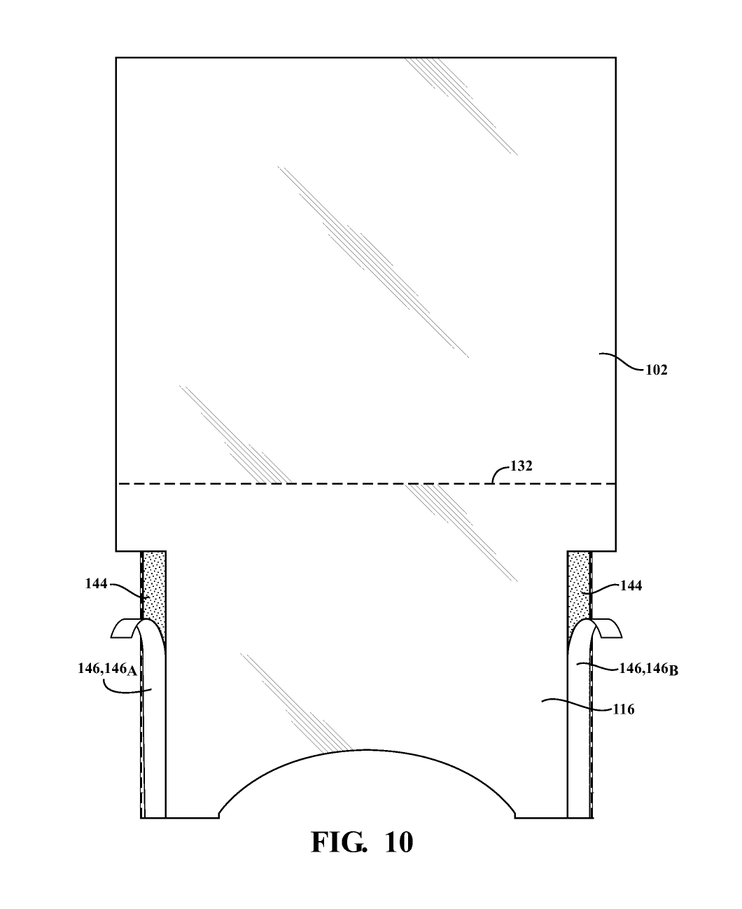

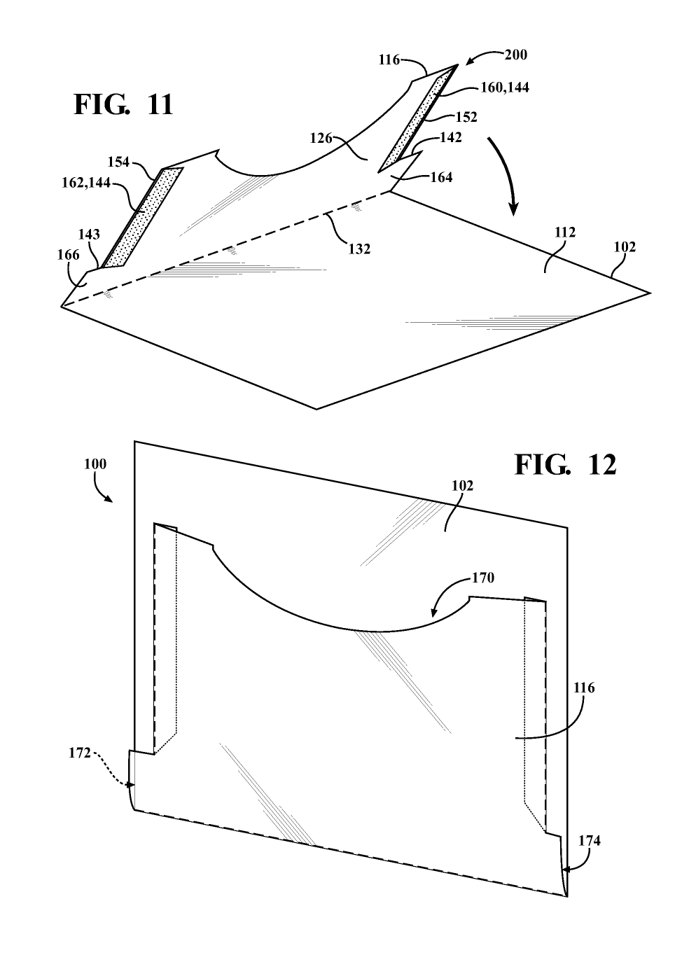

Then, as shown in FIG. 10, first 146_{A} and second 146_{B} strips of the peelable layer 146 are removed from the front layer 116 along the first 152 and second 154 score lines to expose the adhesive layer 144. Upon removing the strips 146_{A}, 146_{B}, and as shown in FIG. 11, the sheet 200 is folded along the seam 132 so that the first 160 and third 162 segments abut and adhere to the interior side 112 of the back layer 102. The second 164 and fourth 166 segments again remain spaced from the back layer 102. When the first 160 and third 162 segments are adhered to the back layer 102, the second 164 and fourth 166 segments in combination with the back layer 102 form the first 172 and second 174 openings. Yet further, when the first 160 and third 162 segments are adhered to the back layer 102, the back 102 and front 116 layers form the pouch 170, and thus the pocket assembly 100. Formation of the pouch 170 and the first 172 and second 174 openings is shown in FIG. 12.

It is to be understood that the method described above may otherwise be accomplished by removing the peelable strips 146_{A} and 146_{B} (shown in FIG. 10) prior to folding the first 160 and third 162 segments along the respective first 152 and second 154 score lines (shown in FIG. 9). It is further to be understood that the folding of the first 160 and third 162 segments (shown in FIG. 9) may be accomplished after the front layer 116 is folded along the seam line 132 (shown in FIG. 11). Still further, the first 160 and third 162 segments may be folded (shown in FIG. 9), then the front layer 116 may be folded along the seam line 132 (shown in FIG. 11) and then the peelable strips 146_{A}, 146_{B} may be removed (shown in FIG. 10). It is to be understood that other arrangements of the manufacturing steps described above are also contemplated herein.

In an example, the method of manufacturing the pocket assembly 100 further includes disposing the adhesive 136 on at least a portion of the exterior side 114 of the back layer 102, and then disposing the peelable layer 138 over the adhesive 136. In some instances, the peelable layer 138 may be scored to form the score line 140 (shown in FIGS. 3 and 4). Additionally, the method may include disposing the adhesive 144 on at least a portion of the exterior side 128 of the front layer 116, and then disposing the peelable layer 146 on the adhesive 144. Then, the front layer 116 is scored to form the score lines 152, 154, as previously mentioned.

In an example, the adhesives 136 and 144 form a single continuous adhesive layer that covers one whole side of the sheet 200 that is fed into the machine(s) for scoring and cutting. Further, the peelable layers 138, 146 form a single continuous peelable layer that covers the entire continuous adhesive layer (i.e., adhesives 136 and 144 in combination). In an example, the adhesives 136, 144 and the peelable layers 138, 146 may be disposed on the sheet 200, and then the sheet 200 is then fed into the machine(s) for scoring and cutting. Disposing of the adhesives 136, 144 and the peelable layers 138, 146 may be accomplished manually (e.g. by a human) or by a machine. In another example, the adhesives 136, 144 and the peelable layers 138, 146 are part of a multi-layered sheet previously manufactured to include the back layer 102, the adhesive 136, and the peelable layer 146, as well as the front layer 116, the adhesive 144, and the peelable layer 146.

While the invention has been described with reference to the examples above, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all examples falling within the scope of the appended claims.

What is claimed is:

1. A pocket assembly for a shipping container comprising:
a back layer comprising first and second opposing back ends and top and bottom back edges extending between said back ends with said back edges spaced from each other along said back ends to define interior and exterior back sides; and
a front layer coupled to said back layer, said front layer comprising:
first and second opposing front ends and top and bottom front edges extending between said front ends with said front edges spaced from each other along said front ends to define interior and exterior front sides;
a first score line spaced inward from said first front end and a second score line spaced inward from said second front end;
a first cut extending inward from said first front end and intersecting said first score line to define first and second segments with said first segment bound by said first front end, said first score line, said top front edge, and said first cut, and said second segment bound by said first front end, said first cut, and said bottom front edge; and
a second cut extending inward from said second front end and intersecting said second score line to define third and fourth segments with said third segment bound by said second front end, said second score line, said top front edge, and said second cut, and said fourth segment bound by said second front end, said second cut, and said bottom front edge;
said first and third segments being folded along said respective first and second score lines such that said first and third segments abut and adhere to said interior back side of said back layer to form a pouch between said front and back layers with said second and fourth segments remaining spaced from said back layer to form first and second openings, respectively, in fluid communication with said pouch.

2. The pocket assembly as set forth in claim 1 wherein said front and back layers are individually formed of a synthetic material, a paper material, or combinations thereof.

3. The pocket assembly as set forth in claim 1 wherein said front layer comprises a coating to receive an ink thereon, said coating being disposed on the exterior front side, the interior front side, or combinations thereof.

4. The pocket assembly as set forth in claim 1 wherein said back layer comprises a coating to receive an ink thereon, said coating being disposed on said exterior back side, said interior back side, or combinations thereof.

5. The pocket assembly as set forth in claim 1 further comprising:
a back adhesive disposed on at least a portion of said exterior back side of said back layer; and
a back peelable layer disposed over at least a portion of said back adhesive with said peelable layer being removable from said back adhesive to expose said back adhesive.

6. The pocket assembly as set forth in claim 1 wherein said bottom front edge is coupled to said bottom back edge to form a seam at said front and back bottom edges.

7. The pocket assembly as set forth in claim 6 wherein said seam is perforated.

8. The pocket assembly as set forth in claim 1 wherein said first and second score lines are perforated.

9. The pocket assembly as set forth in claim 1 wherein said second segment has a length defined between said first cut and said bottom front edge and said fourth segment has a length defined between said second cut and said bottom front edge with said lengths being substantially the same.

10. The pocket assembly as set forth in claim 1 further comprising an adhesive disposed on each of said first and third segments to facilitate said adherence of said first and third segments to said interior back side of said back layer.

11. The pocket assembly as set forth in claim 1 further comprising:
a front adhesive disposed on at least a portion of said exterior front side of said front layer; and
a front peelable layer disposed over said front adhesive with said front peelable layer being removable from said front adhesive along said first and third segments to expose said front adhesive on said first and third segments to facilitate said adherence of said first and third segments to said interior back side of said back layer.

12. The pocket assembly as set forth in claim 1 wherein said first score line has a length defined between said top front edge and said first cut and said second score line has a length defined between said top front edge and said second cut with and said lengths being substantially the same.

13. The pocket assembly as set forth in claim 1 wherein said first opening is defined by said second segment, said bottom front edge, said bottom back edge, and said first back end, and said second opening is defined by said fourth segment, said bottom front edge, said bottom back edge, and said second back end.

14. A shipping container assembly comprising:
a shipping container comprising at least one side wall; and
a pocket assembly coupled to said at least one side wall with said pocket assembly comprising:
a back layer comprising first and second opposing back ends and top and bottom back edges extending between said back ends with said back edges spaced from each other along said back ends to define interior and exterior back sides; and
a front layer coupled to said back layer, said front layer comprising:
first and second opposing front ends and top and bottom front edges extending between said front ends with said front edges spaced from each other along said front ends to define interior and exterior front sides;
a first score line spaced inward from said first front end and a second score line spaced inward from said second front end;
a first cut extending inward from said first front end and intersecting said first score line to define first and second segments with said first segment bound by said first front end, said first score line, said top front edge, and said first cut, and said second segment bound by said first front end, said first cut, and said bottom front edge; and
a second cut extending inward from said second front end and intersecting said second score line to define third and fourth segments with said third segment bound by said second front end, said second score line, said top front edge, and said second cut, and said fourth segment bound by said second front end, said second cut, and said bottom front edge;
said first and third segments being folded along said respective first and second score lines so that said first and third segments abut and adhere to said interior back side of said back layer to form a pouch between said front and back layers with said second and fourth segments remaining spaced from said back layer to form first and second openings, respectively, in fluid communications with said pouch.

15. The shipping container assembly as set forth in claim 14 wherein said pocket assembly further comprises a back adhesive disposed on at least a portion of said exterior back side of said back layer to adhere said pocket assembly to said at least one wall of said shipping container.

16. The shipping container assembly as set forth in claim 14 further comprising at least one securing strip adhered to a portion of said pocket assembly and to said at least one wall of said shipping container.

17. A method of manufacturing a pocket assembly for a shipping container, the pocket assembly having a back layer comprising first and second opposing back ends and top and bottom back edges extending between the back ends with the back edges spaced from each other along the back ends to define interior and exterior back sides, and a front layer coupled to the back layer, the front layer comprising first and second opposing front ends and top and bottom front edges extending between the front ends with the front edges spaced from each other along the front ends to define interior and exterior front sides, the method comprising the steps of:
forming a first score line spaced inward from the first front end;
forming a second score line spaced inward from the second front end;
forming a first cut extending inward from the first front end and intersecting the first score line to define first and second segments, the first segment bound by the first front end, the first score line, the top front edge, and the first cut, and the second segment bound by the first front end, the first cut, and the bottom front edge;
forming a second cut extending inward from the second front end and intersecting the second score line to define third and fourth segments, the third segment bound by the second front end, the second score line, the top front edge, and the second cut, and the fourth segment bound by the second front end, the second cut, and the bottom front edge;
folding the first and third segments along the respective first and second score lines; and
adhering the folded first and third segments to the interior back side of the back layer to form a pouch between the front and back layers with the second and fourth segments remaining spaced from the back layer to form first and second openings, respectively, in fluid communication with the pouch.

18. The method as set forth in claim 17 further comprising the steps of:
disposing a back adhesive on at least a portion of the exterior back side of the back layer; and
disposing a back peelable layer over the back adhesive.

19. The method as set forth in claim 17 wherein the steps of forming the first and second score lines are further defined as forming perforations in the front layer.

20. The method as set forth in claim 17 wherein the bottom front edge is coupled to the bottom back edge to form a seam at the front and back bottom edges, and wherein the method further comprises the step of perforating the seam.

21. The method as set forth in claim 17 further comprising the steps of:
disposing a front adhesive on at least a portion of the exterior front side of the front layer; and
disposing a front peelable layer over the front adhesive.

22. The method as set forth in claim 21 wherein the step of adhering the folded first and third segments to the interior back side of the back layer is further defined as removing the front peelable layer from at least a portion of the front adhesive to expose at least a portion of the front adhesive.
